(19) United States
(12) Patent Application Publication
(10) Pub. No.: US 2025/0153733 A1
(43) Pub. Date: May 15, 2025

(54) METHOD FOR OPERATING AN ASSISTANCE SYSTEM, COMPUTER PROGRAM PRODUCT, AND ASSISTANCE SYSTEM

(71) Applicant: Volkswagen Aktiengesellschaft, Wolfsburg (DE)

(72) Inventors: Philipp Hüger, Rühen (DE); Markus Radimirsch, Letze (DE)

(21) Appl. No.: 18/838,558

(22) PCT Filed: Jan. 31, 2023
(86) PCT No.: PCT/EP2023/052328

§ 371 Date: Aug. 14, 2024

(30) Foreign Application Priority Data
Feb. 15, 2022 (DE) 10 2022 201 554.1
Feb. 18, 2022 (DE) 10 2022 201 731.5

(51) Int. Cl. B60W 60/00; B60W 30/18; B60W 50/00

(52) U.S. Cl. CPC B60W 60/001; B60W 30/18036; B60W 50/0097; B60W 2520/22; B60W 2530/201; B60W 2530/205; B60W 2540/18

(57) ABSTRACT

An assistance system for an at least partially autonomously operated motor vehicle includes a detection device configured to record a trajectory of the motor vehicle during forward movement from a starting point to an endpoint within the vehicle's environment. An electronic computing device within the system determines a further trajectory based on the recorded trajectory for a future reverse movement of the motor vehicle from the starting point to the endpoint. The assistance system utilizes the further trajectory for future autonomous driving. Additionally, the system includes a computer program product associated with the assistance system.

### RELATED APPLICATIONS

The present application claims priority to International Patent Application No. PCT/EP2023/052328 to Phillip Huger et al., filed Jan. 31, 2023, titled “Method For Operating An Assistance System, Computer Program Product, And Assistance System,” which claims priority to German Patent Application No. 10 2022 201 731.5, filed Feb. 18, 2022, and German Patent Application No. 10 2022 201 554.1, filed Feb. 15, 2022, the contents of each being incorporated by reference in their entirety herein.

### TECHNICAL FIELD

The present disclosure is directed to technologies and techniques for operating an assistance system of an at least semi-autonomously operated motor vehicle, in which a trajectory of the motor vehicle, when the motor vehicle is driving forward, in surroundings of the motor vehicle from a starting point to an end point is recorded by means of a detection device of the assistance system. The present disclosure furthermore relates to a computer program product and to an assistance system.

### BACKGROUND

It is already known from the prior art that maneuvering a motor vehicle, in particular when backing up, presents great challenges for a driver. Corresponding problems can arise for a driver especially during the back-up maneuver with a trailer. During maneuvering with a trailer, the driver of the motor vehicle, for example, simultaneously has to reach the trailer articulation angle and the position at the correct time, in particular also in tight driving scenarios.

This driver also has to predefine the correct target articulation angle at the correct time when assisted by a so-called trailer assistance system. It is furthermore known that the wheel odometry for trained parking or maneuvering exhibits inaccuracy regarding the angle and position after a distance has been driven. This may result in collisions with objects in the surroundings.

WO 2014/185828 A1 describes a method for assisting with the reversal of an articulated vehicle.

EP 3744616 A1 relates to a device for reversing an articulated vehicle combination comprising at least two vehicle units interconnected via at least one articulated joint.

### SUMMARY

Aspects of the present disclosure are directed to a method, a computer program product, and an assistance system, in which an improved movement of a motor vehicle can be implemented during an at least semi-autonomous operation.

Certain aspects are disclosed in the respective subject-matter of the independent claims. Further implementations and preferred embodiments are the subject-matter of the dependent claims.

In some examples, a method is disclosed for operating an assistance system of an at least semi-autonomously operated motor vehicle, in which a trajectory of the motor vehicle, when the motor vehicle is driving forward, in surroundings of the motor vehicle from a starting point to an end point is recorded via a detection device of the motor vehicle.

In some examples, the described method may be a computer-implemented method. Another aspect of the present disclosure relates to a computer program product comprising program code, which prompt an electronic processing device to carry out a method according to the present disclosure when the program code is being processed by the electronic processing device. Another aspect of the present disclosure also relates to a computer-readable memory medium. The computer program product can also merely be referred to as a computer program.

Another aspect of the present disclosure relates to an assistance system for an at least semi-autonomously operated motor vehicle, comprising at least one detection device and comprising an electronic processing device, wherein the assistance system is designed to carry out a method according to the preceding aspect. The method may be carried out via the assistance system.

The electronic processing device comprises, for example, processors, circuits, in particular integrated circuits, as well as further electronic components to enable carrying out corresponding method steps.

The present disclosure furthermore also relates to a motor vehicle comprising an assistance system. The motor vehicle has an at least partly autonomous or fully autonomous configuration. In particular, the at least semi-autonomously operated motor vehicle comprises at least means for the longitudinal guidance and for the lateral guidance of the motor vehicle during autonomous operation.

The present disclosure also encompasses refinements of the motor vehicle and of the assistance system which include features such as are described in connection with the refinements of the method. For this reason, the corresponding refinements of the motor vehicle according to the present disclosure and of the assistance system are not described again here for the purposes of brevity.

Aspects of the present disclosure also encompasses the combination of features of the described examples and embodiments.

### BRIEF DESCRIPTION OF THE DRAWINGS

Exemplary embodiments are described hereafter. In the drawings:

FIG. 1 shows a schematic top view onto a first road situation of a motor vehicle including one embodiment of an assistance system, according to some aspects of the present disclosure;

FIG. 2 shows another schematic top view onto another road situation of the motor vehicle including one embodiment of an assistance system, according to some aspects of the present disclosure; and

FIG. 3 shows still another schematic top view onto still another road situation of the motor vehicle including one embodiment of the assistance system, according to some aspects of the present disclosure.

### DETAILED DESCRIPTION

The exemplary embodiments described hereafter are preferred exemplary embodiments of the present disclosure. Each component described within these embodiments represents an individual feature that should be considered independently. These features may also enhance the present disclosure independently, and as such, should be viewed as integral parts of the disclosure, whether individually or in various combinations beyond those illustrated. Additionally, the described exemplary embodiments can be supplemented with other features of the present disclosure.

In the figures, functionally equivalent elements are each denoted by the same reference numerals.

As disclosed herein, a further trajectory for a future backup maneuver of the motor vehicle from a starting point to an endpoint is determined by an electronic processing unit within the assistance system, based on the initial trajectory. This further trajectory is provided to the assistance system to enable autonomous following of the trajectory in future maneuvers.

This system disclosed herein simplifies the process of reversing the motor vehicle along the further trajectory, at least semi-autonomously. For example, a user may follow a trajectory while driving forward with the motor vehicle. The assistance system records this trajectory based on the vehicle's position, using localization methods such as the front camera and internal wheel odometry. A list of waypoints is created as the vehicle moves forward, with these waypoints determined from the vehicle's odometry data, particularly based on the center of the rear axle or the trailer odometry. During the reverse maneuver along the further trajectory, a Stanley controller may be utilized. Additionally, during reversing with a trailer, an articulation angle determination is conducted, potentially using an image processing method applied to backup camera images, similar to a trailer assistance system.

In other words, the system records the vehicle's forward trajectory with the driver's assistance using surroundings detection means such as radar sensors, ultrasonic sensors, LIDAR sensors, or cameras. The system can also detect and account for obstacles or objects along the route. The further trajectory is then determined for a backup maneuver, allowing the vehicle to follow this trajectory from the starting point to the endpoint in reverse. Essentially, the vehicle can be guided in reverse during a future maneuver, with the further trajectory based on the initial forward trajectory. Notably, the direction of movement relative to the surroundings is the same for both the forward and reverse trajectories, although the vehicle moves forward in the initial trajectory and in reverse along the further trajectory.

This system provides advantages, such as allowing the driver easier access to the trunk area, making it more convenient to lift heavy items from the trunk. The vehicle follows the further trajectory in reverse, with steering angles, turning angles, and obstacles taken into account during the maneuver, simplifying the process for the user to reach the endpoint in reverse.

An advantageous embodiment includes recording the trajectory with a trailer attached to the vehicle. The vehicle and trailer, forming a ‘rig,’ can follow the forward trajectory. The system may also autonomously reverse the rig from the endpoint to the starting point, functioning as a trailer assistance system. Different trajectories are required when a trailer is attached compared to when it is not, as the system must account for factors like curve radii, which vary with a trailer.

It is also advantageous to record the trajectory without a trailer attached. This allows the system to determine the further trajectory without the trailer, which can then be followed even if a trailer is later attached. This capability ensures the further trajectory can be learned without a trailer and reliably followed when a trailer is present.

Another embodiment involves following the further trajectory with the trailer attached. Here, the rig follows the forward trajectory with or without the trailer and then follows the further trajectory in reverse as a rig. This embodiment allows for highly comfortable reversing of the rig.

In an additional embodiment, the system considers factors such as the length of the trailer, the length of the vehicle, the position of the trailer hitch relative to the vehicle and trailer, the maximum steering angle of the vehicle, the number of axles on the trailer, the wheelbase of the vehicle and trailer, and the maximum steering angle of the trailer when following the further trajectory. By accounting for these various parameters, which influence both the rig and the vehicle alone, the system enables precise miniature movements to guide the vehicle or rig along the further trajectory.

Another embodiment involves detecting multiple trajectory points for determining the further trajectory. Equidistant further trajectory points are calculated based on these recorded points. These preprocessed points serve as the basis for the reverse maneuver, ensuring that while the vehicle may not follow the trajectory points precisely, the reverse trajectory is generally based on the detected and preprocessed points. This approach balances the target trajectory with possible steering angles.

In yet another embodiment, a trajectory is determined for reversing the vehicle with the trailer from the endpoint to the starting point. The system is designed to autonomously move the vehicle and trailer in reverse along this trajectory, providing a comprehensive assistance system that can at least semi-autonomously follow different trajectories.

Another advantageous embodiment allows the further trajectory to be at least semi-autonomously followed by means of longitudinal and/or lateral guidance of the vehicle, with or without an attached trailer. This enables the vehicle, including an attached trailer, to be moved autonomously in reverse from the endpoint to the starting point, or from the starting point to the endpoint, providing comfortable maneuvering during trailer operation.

It is also advantageous to generate a driving path for the further trajectory, where the vehicle and/or the vehicle with the attached trailer moves during reversing. The system allows for some flexibility within this path, enabling highly precise maneuvers with appropriate compensating movements.

Additionally, during reversing with a trailer, an articulation angle determination may be conducted, for example, using image processing of backup camera images, similar to a trailer assistance system.

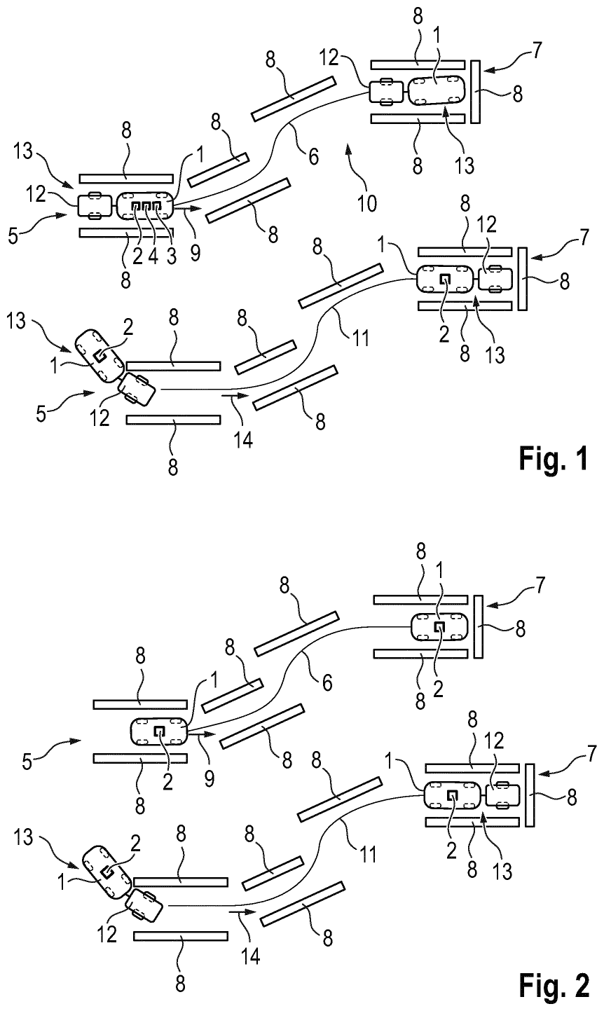

FIG. 1 shows a schematic top view of a motor vehicle 1 in a first situation, including one embodiment of an assistance system 2. The assistance system 2 includes at least one detection device 3 and an electronic processing device 4. The motor vehicle 1 is designed to be at least partly autonomous or fully autonomous, with means for semi-autonomous longitudinal and lateral guidance.

In this example, the motor vehicle 1 is located at a starting point 5. It is driving along a trajectory 6 towards an end point 7, also known as an end position. Along the trajectory 6, several obstacles 8 can be observed. The trajectory 6 is being “learned” in this embodiment.

According to the method for operating the assistance system 2, the detection device 3 records the trajectory 6 of the motor vehicle 1 as it drives forward 9 in the surroundings 10 of the motor vehicle 1, from the starting point 5 to the end point 7 and is recorded by means of the detection device 3. The electronic processing device 4 then determines a further trajectory 11 for a future backup maneuver 14 of the motor vehicle 1, from the starting point 5 to the end point 7, based on the trajectory 6. This further trajectory 11 is provided to the assistance system 2 for autonomous following in the future.

In this embodiment, the trajectory 6 is recorded specifically with a trailer 12 attached to the motor vehicle 1. The further trajectory 11 is also followed with the trailer 12 attached to the motor vehicle 1. The motor vehicle 1 with the attached trailer 12 can also be referred to as a rig 13.

Additionally, the following factors may be taken into consideration when following the further trajectory 11: the length of the trailer 12 and/or the length of the motor vehicle 1, the position of the trailer hitch in relation to the motor vehicle 1 and the trailer 12 (specifically the articulation angle), the maximum steering angle of the motor vehicle 1, the number of axles of the trailer 12, the wheelbase of the motor vehicle 1 and the wheelbase of the trailer 12, and the maximum steering angle of the trailer 12.

Furthermore, it may be necessary to detect multiple trajectory points in order to determine the further trajectory 11. Equidistant further trajectory points can be determined based on the detected trajectory points.

Furthermore, it is in particular provided that at least the further trajectory 11 is at least semi-autonomously followed by means of longitudinal guidance of the motor vehicle 1 and/or of the motor vehicle 1 including the attached trailer 12 and/or by means of lateral guidance of the motor vehicle 1 and/or of the motor vehicle 1 including the attached trailer 12.

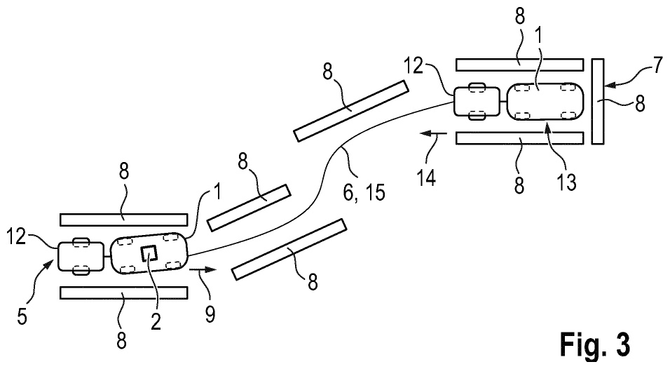

FIG. 1, in particular, shows the so-called trained maneuvering of a previously recorded trajectory 6, with the orientation inverted for the backup maneuver 14. To train for this, the user or driver of the motor vehicle 1 drives forward with the trailer 12 to the end position or end point 7. To drive out from this position, a backup assistance system, illustrated in FIG. 3, can be used. When the motor vehicle 1, including the trailer 12, enters the end position or end point in the future, the assistance system 2 is activated. It allows the motor vehicle 1 to follow the trajectory 6 designed for the backup maneuver 14 or the further trajectory 11, enabling loading or unloading of the trailer 12 at the end point 7. Afterward, the motor vehicle 1, along with the attached trailer 12, can drive forward out of the end position or end point 7.

In FIG. 2, a different scenario is presented, where the motor vehicle 1 utilizes the assistance system 2. This figure shows the trained maneuvering of the previously recorded trajectory 6, but with a rotated orientation. However, this trajectory 6 was only recorded or trained by the motor vehicle 1 itself, without an attached trailer 12. The user or driver of the motor vehicle 1 can reach the end point 7 by driving forward 9 without a trailer 12. The trajectory 6 is recorded during this process. Alternatively, the motor vehicle 1 can also be reversed to reach the end point 7. In the future maneuver, the assistance system 2 can be activated. This time, the motor vehicle 1, with the attached trailer 12, can follow the further trajectory 11 via the backup maneuver 14. This allows for loading or unloading of the trailer 12 at the end point 7, and subsequently driving the motor vehicle 1, along with the attached trailer 12, forward. It is important to note that the determination of the end position of the rig 13 at the end point 7 should take into account the trailer length and offset, to ensure timely stopping. This offset should be considered in comparison to the trained driving into the end position without the trailer 12.

In particular, the end position of the motor vehicle 1 is corrected by the trailer length so that the rig 13 stops at the end point 7 with a specific distance from the end position.

Furthermore, a wheel odometry correction is carried out to address any inaccuracies in the xy position and angle of the wheel odometry. Localization, such as using the front camera or the detection device 3, can support or correct the wheel odometry.

FIG. 3 shows another road situation of the motor vehicle 1 with the attached trailer 12. In this example, it is shown that the motor vehicle 1 can drive to the end point 7 by moving forward 9 from the starting point 5. The trajectory 6 is recorded during this process. Then, during the back-up maneuver 14, the rig 13 can reach the starting point 5 from the end position or end point 7. This is done at least semi-autonomously, with longitudinal guidance and lateral guidance of the motor vehicle 1.

Another trajectory 15 illustrates this in the current example. The method described only allows the motor vehicle 1 to provide longitudinal guidance and lateral guidance. However, if the trailer 12 also has corresponding motors and steering, it would be possible to carry out corresponding lateral guidance and longitudinal guidance for the trailer. This can be done, for example, by activating the trailer's wheels differently. The assistance system 2 can then send corresponding commands to the coupled trailer, such as through control signals, to assist with autonomous movement.

### LIST OF REFERENCE NUMERALS

1 motor vehicle
2 assistance system
3 detection device
4 electronic processing device
5 starting point
6 trajectory
7 end point
8 object
9 driving forward
10 surroundings
11 further trajectory
12 trailer
13 rig
14 back-up maneuver
15 still another trajectory

1-15. (canceled)

16. A method for operating an assistance system of an at least semi-autonomously operated motor vehicle, the method comprising:
recording a trajectory of the motor vehicle when the motor vehicle is driving forward from a starting point to an endpoint in surroundings of the motor vehicle using a detection device of the assistance system; and
determining, based on the recorded trajectory, a further trajectory for a future backup maneuver of the motor vehicle from the starting point to the endpoint using an electronic processing device of the assistance system; and
providing the further trajectory to the assistance system for autonomously following the further trajectory in the future.

17. The method of claim 16, wherein the trajectory is recorded when (i) a trailer is attached to the motor vehicle, or (ii) when the motor vehicle does not have a trailer attached.

18. The method of claim 16, further comprising autonomously following the further trajectory in the presence of a trailer attached to the motor vehicle.

19. The method of claim 16, further comprising considering at least one of the following factors when following the further trajectory:
a length of the trailer;
a length of the motor vehicle;
a position of a trailer hitch relative to the motor vehicle and the trailer;
a maximum steering angle of the motor vehicle;
a number of axles of the trailer;
a wheelbase of the motor vehicle;
a wheelbase of the trailer; and
a maximum steering angle of the trailer.

20. The method of claim 16, further comprising:
detecting a plurality of trajectory points of the recorded trajectory; and
determining a plurality of equidistant further trajectory points for the further trajectory based on the detected trajectory points.

21. The method of claim 16, further comprising determining another trajectory for reversing the motor vehicle with an attached trailer from the endpoint to the starting point during the backup maneuver.

22. The method of claim 16, wherein the further trajectory is at least semi-autonomously followed by providing longitudinal guidance and/or lateral guidance of the motor vehicle, with or without an attached trailer.

24. The method of claim 16, further comprising generating a driving path for the further trajectory, wherein the motor vehicle, with or without an attached trailer, follows the driving path during the backup maneuver.

25. The method of claim 24, further comprising one of:
(i) maintaining the motor vehicle, with or without an attached trailer, within the generated driving path by performing miniature movements of the motor vehicle, or
(ii) maintaining at least one rear axle point of the motor vehicle and/or a rear axle point of the trailer within the generated driving path.

26. The method of claim 16, further comprising determining an articulation angle during the backup maneuver when a trailer is attached to the motor vehicle.

27. An assistance system for an at least semi-autonomously operated motor vehicle, the system comprising:
at least one detection device configured to record a trajectory of the motor vehicle when the motor vehicle is driving forward from a starting point to an endpoint in surroundings of the motor vehicle; and
an electronic processing device configured to:
determine, based on the recorded trajectory, a further trajectory for a future backup maneuver of the motor vehicle from the starting point to the endpoint; and
provide the further trajectory to the assistance system for autonomously following the further trajectory in the future.

28. The assistance system of claim 27, wherein the detection device is configured to record the trajectory when (i) a trailer is attached to the motor vehicle, or (ii) when the motor vehicle does not have a trailer attached.

29. The assistance system of claim 27, wherein the electronic processing device is further configured to autonomously follow the further trajectory in the presence of a trailer attached to the motor vehicle.

30. The assistance system of claim 27, wherein the electronic processing device is further configured to consider at least one of the following factors when following the further trajectory:
a length of the trailer;
a length of the motor vehicle;
a position of a trailer hitch relative to the motor vehicle and the trailer;
a maximum steering angle of the motor vehicle;
a number of axles of the trailer;
a wheelbase of the motor vehicle;
a wheelbase of the trailer; and
a maximum steering angle of the trailer.

31. The assistance system of claim 27, wherein the electronic processing device is further configured to:
detect a plurality of trajectory points of the recorded trajectory; and
determine a plurality of equidistant further trajectory points for the further trajectory based on the detected trajectory points.

32. The assistance system of claim 27, wherein the electronic processing device is further configured to determine another trajectory for reversing the motor vehicle with an attached trailer from the endpoint to the starting point during the backup maneuver.

33. The assistance system of claim 27, wherein the electronic processing device is configured to at least semi-autonomously follow the further trajectory by providing longitudinal guidance and/or lateral guidance of the motor vehicle, with or without an attached trailer.

34. The assistance system of claim 27, wherein the electronic processing device is further configured to generate a driving path for the further trajectory, wherein the motor vehicle, with or without an attached trailer, follows the driving path during the backup maneuver.

35. A non-transitory computer-readable storage medium storing instructions that, when executed by an electronic processing device of an assistance system for an at least semi-autonomously operated motor vehicle, cause the electronic processing device to:
record, using a detection device, a trajectory of the motor vehicle as the motor vehicle drives forward from a starting point to an endpoint in surroundings of the motor vehicle;
determine, based on the recorded trajectory, a further trajectory for a future backup maneuver of the motor vehicle from the starting point to the endpoint; and
provide the further trajectory to the assistance system for autonomous following of the further trajectory in the future.
